(19) United States
(12) Patent Application Publication
(10) Pub. No.: US 2016/0311161 A1
(43) Pub. Date: Oct. 27, 2016

(54) SPECTRAL GRADIENT FILTER PRODUCTION USING SURFACE APPLIED ARRAY OPTIMIZED 3D SHADOW MASKS

(71) Applicant: PIXELTEQ, INC., Largo, FL (US)

(72) Inventor: JAMES D. LANE, DUNEDIN, FL (US)

(21) Appl. No.: 15/098,375

(22) Filed: Apr. 14, 2016

Related U.S. Application Data
(60) Provisional application No. 62/151,478, filed on Apr. 23, 2015.

(51) Int. Cl. B29C 67/00; G02B 5/20; G01J 3/12

(52) U.S. Cl. CPC B29C 67/0059; G01J 3/12; G02B 5/20; B33Y 10/00

(57) ABSTRACT

A method of producing spectral gradient filters using surface applied array optimized 3D shadow masks by placing the shadow mask on the surface of the wafer substrate using a technique such as 3D printing, and by also using spatial algorithms to shape each mask aperture individually is disclosed.

### CROSS-REFERENCE TO RELATED APPLICATION

The present application claims the benefit of previously filed co-pending Provisional Patent Application, Ser. No. 62/151,478, filed Apr. 23, 2015.

### FIELD OF THE INVENTION

This invention belongs to the field of spectral gradient filter coatings. More specifically it is a method of producing spectral gradient filters using surface applied array optimized 3D shadow masks.

### BACKGROUND OF THE INVENTION

Gradient optical filter coatings have been created by various methods on discrete optical components for some time. Current production methods typically depend on a combination of relative spatial parallax shadowing or mechanical indexing of relative position between the substrate to be coated and the mask.

While many types of filter coatings that were once coated on a cover glass and then bonded to an optoelectronic device are now being successfully deposited directly on the devices while still at the wafer level, gradient optical filters have found it difficult if not impossible to make a similar transition from cover glass to direct deposit. At the wafer level, multiple optoelectronic devices are laid out in a 2D array, so current shadow mask methods are not able to create identical gradient filter results for all devices on the wafer. This is because each aperture needs to be slightly different to achieve the correct resultant gradient as deposition rates will vary from die to die due to the geometry of the deposition tool. This invention provides each device on the wafer a uniquely shaped shadow mask aperture based on its specific position and orientation on the wafer and in the filter process tool as well.

By using the spectral gradient filter production method disclosed in this application the prior art's limitations described above can now be overcome.

### BRIEF SUMMARY OF THE INVENTION

The invention of this disclosure is a method of producing spectral gradient filters using surface applied array optimized 3D shadow masks.

### BRIEF DESCRIPTION OF THE DRAWINGS

For a fuller understanding of the nature and objects of the invention, reference should be made to the following detailed description, taken in connection with the accompanying drawings, in which:

FIG. 1 is a diagram showing the Wafer with Release Layer and Shadow Mask added; and,

FIG. 2 is a diagram showing repeated identical Shadow Mask Apertures on a wafer.

### DESCRIPTION OF THE PREFFERED EMBODIMENT

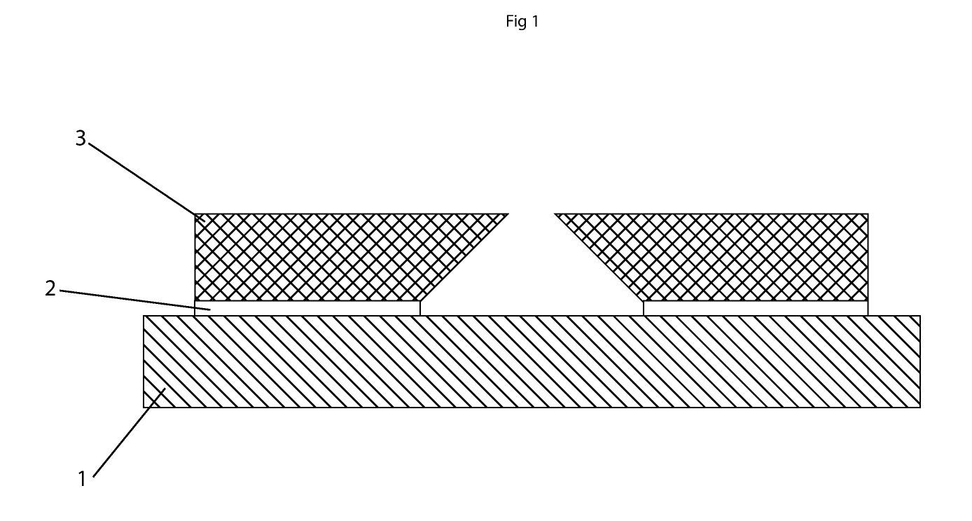

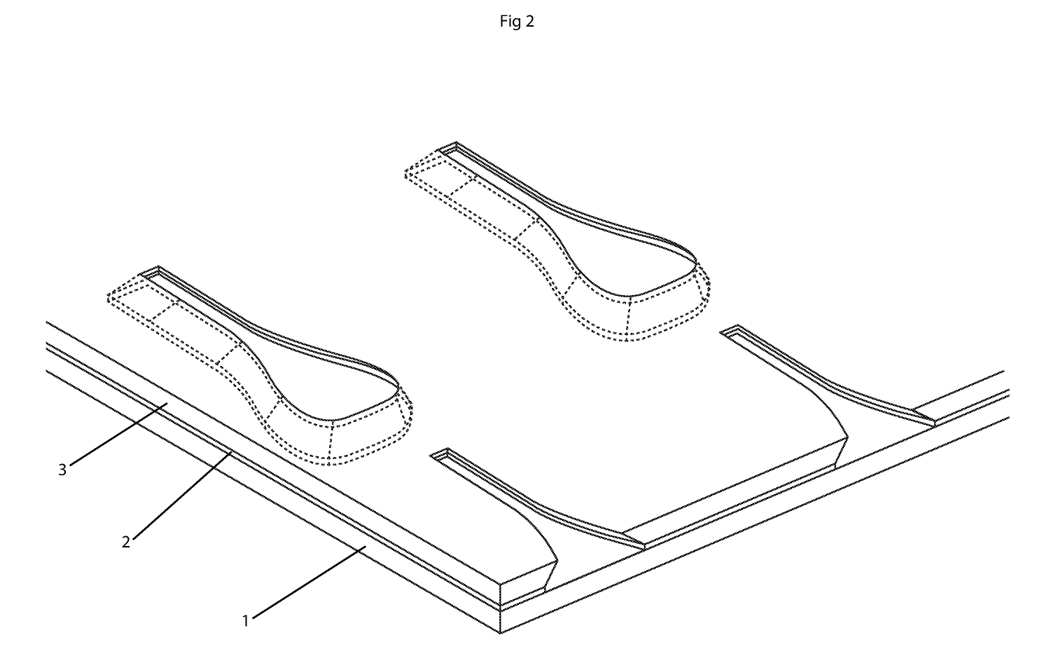

The preferred embodiment of this method discloses that by placing the shadow mask (3) on the surface of the wafer substrate (1) covered with a release layer (2) as shown in FIG. 1 using a technique such as 3D printing, and by also using spatial algorithms to shape each shadow mask (3) aperture individually, the resultant gradient optical filter coating that is deposited through the associated shadow mask (3) aperture and onto the device below is optimized to be similar in specification and function to all the other devices on the wafer (1) as shown in FIG. 2, and from wafer (1) to wafer (1) in the production batch lot. This method provides each device on the wafer (1) a uniquely shaped shadow mask (3) aperture based on its specific position and orientation on the wafer (1) and in the filter process tool as well.

The release layer (2) may be LOR, photoresist, another suitable release agent, or the 3D printed layer may be created in direct contact with the wafer substrate (1) in conjunction with the appropriate liftoff and removal processes.

In the preferred embodiment the shadow mask (3) array element determination is calculated by classical geometric methods as follows:

Inputs of xy location, gradient %, wafer (1) location on coating fixturing, planet geometry wrt deposition source, planetary rotational geometry.

Output is an individualized shadow mask (3) profile shape to yield the desired gradient filter for each device of the wafer (1) array.

Shadow mask (3) apertures can also be calculated using high level shadowing and gradient routines running on a suitable graphics processing engine. A deterministic correction algorithm may be employed as needed to optimize the shadow mask (3) shapes to achieve additional conformance to the desired specification or design.

Applications for this novel method include:

Linear variable filters (gradient in 1 direction) such as the incorporation of a micro-LVF on an active device or on glass aligned to an active device for the purpose of doing spectrographic sensing on a cell phone, tablet or any other application specific device.

Graded filter arrays (gradient in 2 directions).

Generation of “soft” graded filter edges for improved optical, mechanical or environmental characteristics.

Can be used to produce localized “blanket” antireflection or environmentally resistant films.

A gradient filter produced by this method can be applied on top of a non-graded spectral filter coating such as a wide band filter to create a composite graded filter.

Multiple cycles of gradient filters can be sequentially processed on a wafer to create adjacent groupings or stacked multispectral regions across a 2D field or array.

Graded metal neutral density filters.

Graded metal/dielectric hybrid films.

Graded spacer layers for variable bandpass filters, including Fabry Perot filters.

Since certain changes may be made in the above described spectral gradient filter production method without departing from the scope of the invention herein involved, thus it is intended that all matter contained in the description thereof or shown in the accompanying figures shall be interpreted as illustrative of the claims and not in a limiting sense.

What is claimed is:

1. A method of producing a spectral gradient filter placed on a device on a wafer and optimized to be similar in specification and function to all the other spectral gradient filters placed on devices on a wafer using surface applied array optimized three dimensional shadow masks comprising:
covering a wafer containing two or more devices with a release layer;
then determining the deposition geometry required to form the shape of each individual shadow mask aperture that results in the same filter spectral gradients for each of said two or more devices on a wafer; and,
then using three dimensional printing to deposit said determined shadow mask apertures on said release layer on said wafer.

2. The method of claim 1 repeated for multiple cycles on a wafer to create adjacent groupings or stacked multispectral regions across a two dimensional field or array.

3. The method of claim 1 wherein said shadow mask apertures are three dimensionally printed directly on said wafer.

4. The method of claim 3 repeated for multiple cycles on a wafer to create adjacent groupings or stacked multispectral regions across a two dimensional field or array.

5. A micro-linear variable filter positioned on an active device or on glass aligned to an active device using the method of claim 1 for the purpose of doing spectrographic sensing on a cell phone, tablet or other application specific device.
